(19) United States
(12) Patent Application Publication
(10) Pub. No.: US 2015/0062440 A1
(43) Pub. Date: Mar. 5, 2015

(54) Apparatus, method and system for motion recording of a remote device and presentation of useful information thereof

(71) Applicants: Glenn Austin Baxter, Longmont, CO (US); Shane Cody Schulz, Longmont, CO (US)

(72) Inventors: Glenn Austin Baxter, Longmont, CO (US); Shane Cody Schulz, Longmont, CO (US)

(21) Appl. No.: 14/017,898

(22) Filed: Sep. 4, 2013

(51) Int. Cl. H04N 5/44

(52) U.S. Cl. CPC H04N 5/4403
USPC 348/734

(57) ABSTRACT

A remote device includes a sensor platform, memory, communication means, control mechanism and power supply. The remote device being capable of emitting time stamped sensor data or information to sense movement, position, spin and time. A means of receiving said communication, analyzing the data or information, calculating and displaying a visualization of the resultant time, motion, and effect of impingement on the remote device. Visualizations provided for training purposes to the user of the remote device might consists of historical visualizations of that user, or even of other users so that a comparison may be made by the user to improve their skill in the present use of the remote device. A means to provide visualizations in near real time to judges and spectators to view the particular sport. A means of visualizing multiple remote devices to understand all the elements in motion in a particular sport.

### FIELD OF THE INVENTION

The present invention relates to the field of motion movement capture, motion movement analytics, and motion movement visualization, particularly when applied to sports.

### BACKGROUND OF THE INVENTION

Today there are no low cost means for people to visualize their performance in a sport. The means that exist for tracking the movement of a ball on a field all suffer deficiencies. Among those is cost, portability, and ultimate utility. Further, prior art does not directly offer the ability to see both short term or long term events that are beyond the ability of a human to perceive without some form of visualization and means to play the visualization backwards and forwards, pausing at any particular part of the visualization. There is a need for an apparatus, method and system to provide not only low cost visualization of performance, but also to provide means for spectators to benefit from visualizations.

### BRIEF SUMMARY OF THE INVENTION

The present invention imagines a remote device which is capable of measuring time and a number of other sensor parameters, memorizing those data points in a memory, and then transmitting those data points at appropriate times to a receiving station. Importantly, as technology develops, it will be possible for the remote device to perform data analytics calculations within the remote device and to transmit resultant information with or instead of the raw data. The receiving station is capable of reception, means to accomplish data analytics, and means to provide visualizations to the user of the remote device. Further, the receiving station can provide such visualization to others for scoring, judging, or simply viewing purposes. Said visualizations can be used directly, or in combination with other visualizations to provide feedback and training to the user of the remote device. In most instances of sport, said remote device would be embedded within the puck or ball in use for that sport. Similarly, it is envisioned that a player in such sport would use their smart phone to receive and visualize such information, whereas a coach, teacher, judge or spectator might use another means such as a television or tablet computer to see the resultant information display. Scientists and researchers might prefer to see the raw information in order to derive new and useful algorithms.

### BRIEF DESCRIPTION OF THE FIGURES

FIG. 1 illustrates prior art systems

FIG. 2 illustrates an example embodiment of the present invention

FIG. 3 represents an example block diagram and example physical representation of a remote device

FIG. 4 represent a use example of a remote device when combined with GPS satellites

### DETAILED DESCRIPTION OF THE INVENTION

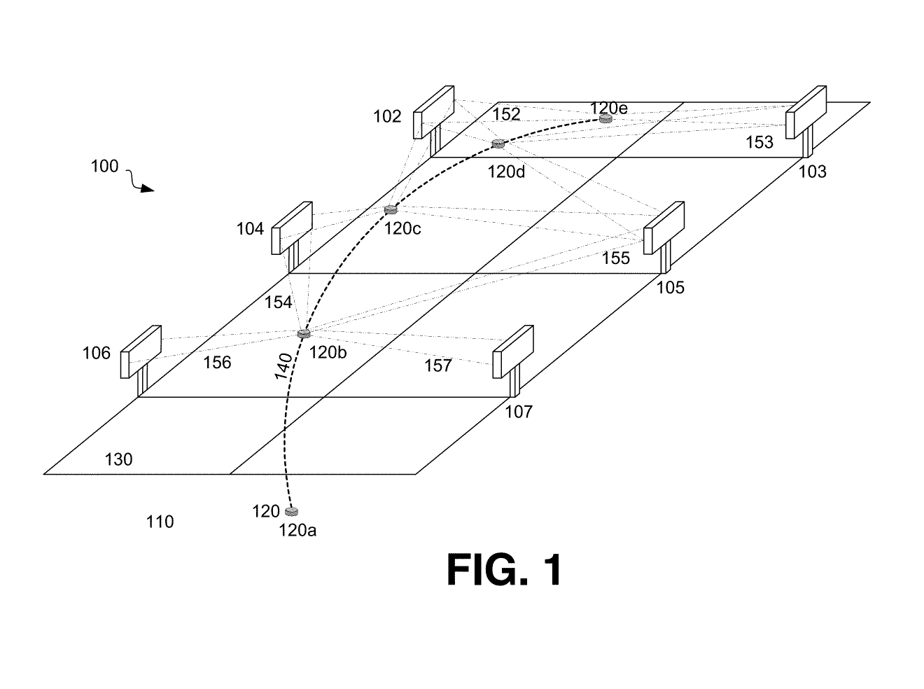

FIG. 1 demonstrates a wide variety of examples of prior art systems that seek to track a remote device 120 through medium 110. Prior Art 100 consists of a medium 110 which might be air or water; and which may include some kind of multidimensional planar surface 130 such as concrete, or the hills of a golf course; one or more sensors 102, 103, 104, 105, 106 and 107; an initial remote device position and static motion at position and time 120a, following a one or more dimensional trajectory 140 across space and time, for example at position and time 120b, 120c and 120d, and finally coming to rest at position and time 120e.

Prior Art 100 can use techniques such as Radio Frequency (RF) IDentification (RFID), after Rahimi (U.S. Pat. No. 8,451,119) and similar, or “radar” like techniques after Savarese (U.S. Pat. No. 8,226,495) and similar. In all prior art systems, some form of sensor, external to remote device 120 is used to gather information about remote device 120. Those skilled in the art will understand that sensor(s) can be hidden from view, but in many instances require a line of site to the remote device, for example a video camera. Further, any sensor that can be made to sense the temporal position of remote device 120 can be employed. Examples include video cameras, LASERs, RADAR, RFID, or differential RF devices. In our simplistic example of FIG. 1, Prior Art 100 is on a multidimensional planar surface 130, say a soccer field, and the remote device 120 is a soccer ball going along a particular trajectory 140. As it goes along the trajectory 140, it is possible to know where the ball is spatially in 3D within medium 110 (in this case air), simply by recording the time, distance and direction to the remote device 120 from one or more sensor 102-107. In this example, our sensors have “beams” which are emitted by either the remote device 120, and detected by the sensors 102-107, or are emitted by the sensors 102-107 and detected by the remote device 120. For example, beams 156, 157, 154 and 155 can be used to find remote device 120 at position and time 120b. One example system is in use at Top Golf, Inc. using RFID tags and sensors made by Impinj. This system places an RDIF tag into a ball, and then uses the sensors to read the RFID tag, and to identify its position at a particular moment in time. With sophisticated processing of data, it is possible to generate a virtual 3D track through the medium of a remote device, in this case a ball. This processed information can in turn then be presented to a user via means not disclosed in prior art, and used by a player to better learn how to hit a ball.

In another example of prior art 100, the sensors are instead made mobile, indeed handheld in case of Savarese, and this large and unwieldy hand held unit is used to locate a lost ball. Making the sensor mobile is useful because it means it can be applied anywhere, and in that way, Savarese et al teachings on the use of radio frequency finding techniques is actually superior over RFID style systems after Rahimi.

There are also examples where real RADAR is used to track the trajectory of the remote device, but these are typically limited to line of site usage. Thus, in a golf course where there are hills, it might not be possible to follow the full trajectory of the remote device. Please note that these systems also suffer from enormous expense and potential for harm to humans and other animals due to the harmful radio frequencies involved in typical RADAR systems. Further this system suffers from not being easily portable.

What is needed then is a superior apparatus, method and system for following a remote device as it moves about within any particular medium. The present invention demonstrates a vastly superior means of tracking a remote device 120. In fact, with the new capabilities of the present invention, it is possible to do complex mathematical analysis and derive highly valuable information to the users or watchers of remote devices. The remainder of the description will focus on describing in detail sufficient so that one skilled in the art could create one or more embodiments of the present invention. It should also be noted that those skilled in the art will immediately recognize that there are many variants to the general principles herein taught, and that the scope of the invention is limited only to the claims herein.

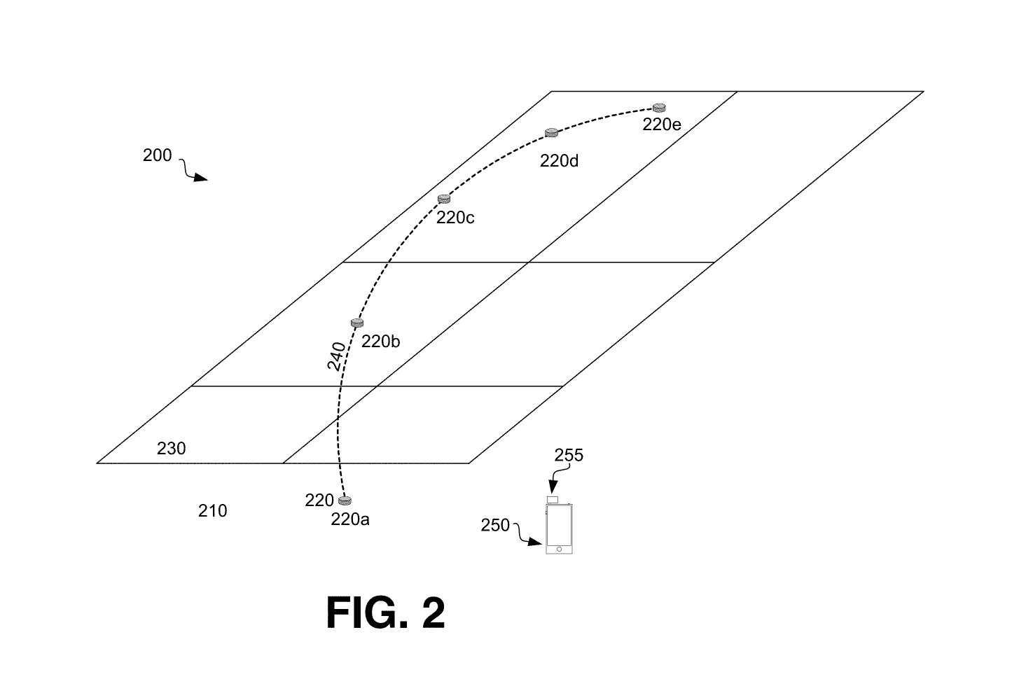

FIG. 2. demonstrates the general principles of the invention. This demonstration follows similar syntax to prior art 100 so that comparison can be made. Remote device 220 is shown in various positions and times (220a, 220b, 220c, 220d, 220e) along a simplified trajectory 240 within medium 210, in this case along a multidimensional planar surface 230. Note that multidimensional planar surface 230 is vastly simplified to be simple plane whereas in real life it could be some location on the earth with hills, valley, water, rocks, holes, etc. Significantly, the present invention does not require sensors 102-107 of prior art 100 to be placed within medium 210 or multidimensional planar surface 230.

Given a particular kind of imputed energy to remote device 220, it will follow a particular complex trajectory 240 and arrive, in time and distance order from initial rest spatial-temporal position 220a to temporary spatial-temporal position 220b, then to 220c, then to 220d, and finally expending its energy come to final rest spatial-temporal position 220e. Note that in most, but not all contexts, initial rest position 220a and final rest position 220e will exist somewhere in physical space of multidimensional planar surface 230.

The significant departure of the present invention is that remote device 220 has embedded within it (not shown in FIG. 2.) the appropriate sensors, memory and communications means to enable the remote device itself to sense the passage of time, and the movement through medium 210, as well as contact (if any) with multidimensional planar surface 230. In prior art 100, sensors 102-107 exist outside remote device 120. According to one embodiment of the present invention, remote device 220 will contain 3D accelerometers and 3D magnetometers to detect its movement through medium 210, and/or contact with multidimensional planar surface 230. Such sensors permit remote device 220 to sense motion or contact and then to use the embedded memory to store the present values of the sensors along with a time stamp. Simple reconstruction of a time ordered list of values can yield position, motion, and time data that prior art 100 must achieve through very different means. The embedded memory can act like a video tape and use the communication means in remote device 220 to express the data to an external agent.

According to one embodiment of the present invention, the external agent might be a smart phone, or tablet computer 250 shown attached to some form of communication device 255. For example, smart phone 250 could be an iPhone 5 manufactured by Apple Computer of Cupertino, Calif. Communication device 255 could be embedded with smart phone 250, even though FIG. 2 shows it external. Changing the sensing platform from an external one to an internal one is very different from prior art.

In particular, prior art 100 is not portable in so far as sensors 102-107 are large fixtures, typically permanently installed in a particular location. Thus one could not simply take the remote device 120 to a different place and have the sensing work. While Savarese does indeed teach of a portable sensor, that sensor both lacks and anticipates the need for any additional data other than spatial end location 120e. In fact, Savarese only application is final location of remote device 120, and lacks any means of temporal nature to understand trajectory 140. Further, while sensors in prior art devices are remarkable, they are not capable of identifying every relevant fact that users of remote devices may need or want to know. For example, none of the prior art teaches about how to find spin on a ball, or to measure its affect on the trajectory, nor do they discuss a means to identify how changes in medium 130 can affect trajectory 140, nor to identify any means to actually calculate the effects or values thereof. Additionally, if someone wished to make the remote device alter its own trajectory through some particular means, the prior art is silent on how it could be done. The reason it is silent is because the prior art has no means to express such because the intended applications are more about direction finding than providing analytics to the user of remote device 120.

In contrast, the present invention's inclusion of sensors, memory and communication means allows the present invention to do far more than prior art. Significantly, adding the means to remember the sensed data, and the ability to recall it remotely is of great value. In the preferred embodiment of the present invention, the sensor platform and memory together form an inertial navigation platform. That inertial navigation platform could be used simply to remember where and when a remote device 220 was in a particular place. It could also be used to affect where the final resting place 220e would be. It is capable of this action expressly because it has access to all the relevant data to in-flight calculate a conclusion of its trajectory. To accomplish the impingement on path of flight, the remote device need only be equipped with a means to change its shape or direction controlled by the onboard processing agent. This is impossible with prior art because no such intelligence exists within the remote device, nor is there an envisioned means to change shape or direction, even if the RF system could broadcast back the appropriate calculated changes. On these the prior art is totally silent.

The means of communication itself within remote device 220 has strong utility as well. In particular, if one wants to know where remote device 220 came to rest in its final resting position 220e, remote device 220 can literally tell you because it has the means to directly communicate the relevant data needed to determine the location. By implication, this means that one can always find remote device 220, at least as long as its power source holds out and communication means 370 can produce a detectable signal that broadcasts data. Note that the preferred embodiment embeds within remote device 220 the calculation power required to identify location relative to initial rest position 220a. It is equally possible that remote device 220 simply broadcasts the spatial-temporal data it collected to allow an external means to do the calculation. It is further possible that remote device 220 can broadcast spatial-temporal data in bursts or aperiodically along trajectory 240. In either of these cases, remote device 220 has substantial capability that remote device 120 lacks.

In the preferred embodiment of the present invention, the means of communication is a Radio Frequency (RF) modem. This RF modem need not use the direction and range methods illustrated in prior art as taught by Savarese et al, though it could certainly use such techniques as well. Instead, the RF modem is used to broadcast the data from the remote device to a waiting receiving station, such as smart phone 250 coupled with communication device 255. It is also possible to use other means to communicate such as light, motion, movement, or even heat. Those of ordinary skill in the art will recognize that smart phone 250 coupled with communication device 255 is a proxy for any number of systems which contain similar kinds of functionality. Included within such systems would be a means to communicate, a means to received and process data into useful information, a means to display visualizations of the information, and a means to overlay multiple data sets and informations so that human sensitive visual comparisons can be made. For example, it is possible to have a communication means attached to a computer, have the computer send the received data into a cloud based computer to do the data analytics and visualization, and then send the presented visualization to yet another display device which sufficient capabilities to present the visualization. Smart phone 250 in concert with communication device 255 thus anticipate many different methods of achieving the visualization to the end user.

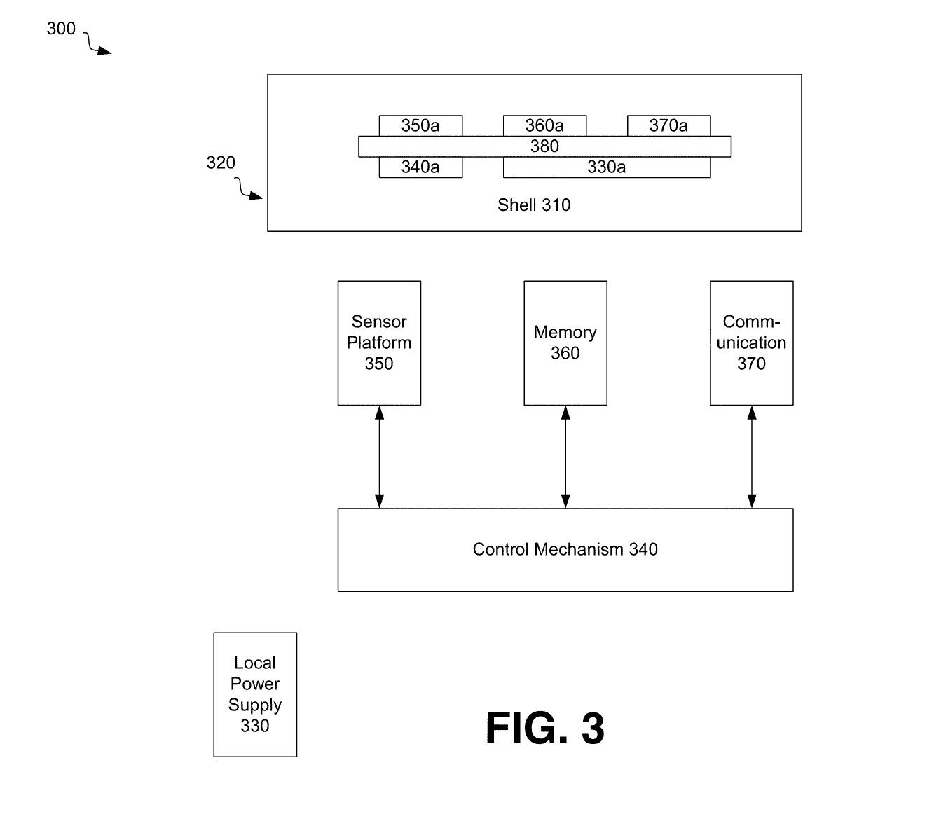

FIG. 3. shows an illustration of an example construction view of remote device 320 and a block diagram of the system contained within remote device 320 in accordance with one embodiment of the invention. Remote device 320 is physically housed in shell 310 appropriate to the intended function of remote device 320, such shell having printed circuit board 380 used to interconnect sensor platform device 350a, memory device 360a, communication device 370a, control mechanism device 340a and local power supply device 330a. Those skilled in the art will appreciate that many arrangements are possible to contain one or more devices that collectively houses 330a to 370a devices. For example, it is possible to build a single chip computer which has a built in 3D accelerometer, built in 3D magnetometer, built in memory, and built in RF modem. It is also reasonable to group functions such as acceleration and magnetometer measurement with a memory into a single device. Any such arrangement which substantially has the function of sensor data being stored in a memory and with the ability to broadcast that data with a means to effect control between these elements is expressly anticipated by this invention, regardless of its specific design implementation.

FIG. 3 also shows a block diagram of the main elements of the present invention relating to a remote device. Specifically, the remote device consists of a local power supply 330 which provides power to the rest of the system for the intended life of the remote device. Note that local power supply 330 may feature an external means of recharging the power storage means external to the remote device 320 using any of a number of wired or wireless technologies available. Control Mechanism 340 is included to manage the data from the sensor platform 350, provide a temporal context to that data, and then to store into memory 360 the time and data appropriate to sensor platform 350, and/or to broadcast the time and data via communication means 370. Control mechanism 340 is also capable of listening to commands from communication means 370 to provide useful computation and/or data gathering/data analysis based on a request over communication means 370. One example of such request is to send the data from the initial impingement event to the end of the data record across communication means 370. Another example is for control mechanism 340 to receive a request via communication means 370 for control mechanism 340 to compute information from the data coming from sensor platform 350 and/or from memory 360 to provide information that is deemed useful by the user of remote device 320. In most embodiments, control mechanism 340 would consist of a micro controller or other lower power central processing unit. In the preferred embodiment, sensor platform 350 consists of a single chip system housing a 3D accelerometer, a 3D magnetometer, and an optional temperature sensor along with appropriate “computing” to at least provide raw accelerometer, magnetic and other sensor data to the outside world. It is also possible that sensor platform 350 contains large amounts of computing so that it can actually provide information rather than just data. In this context, information is content derived from the raw data such as direction, motion, rotation axis and rate of rotation, etc.

Memory 360 is any of a number of different memory technologies including NAND or NOR flash, DRAM, SRAM, RRAM, or some yet to be invented technology. The memory can be volatile or non-volatile so long as the contents last at least long enough for the data and/or information contained in memory 360 to be transported to an external agent via communication means 370.

Communication means 370 is simply a means in any of a number of methods to at least output data from either the sensor platform 350, the memory 360 or the control mechanism 340, as appropriate. Communication means 370 may also include a receive capability so that the external agent (e.g. smart phone 250 via communication device 255) can send commands or queries to the control mechanism 340. These commands may in turn result in a functional change of sensor platform 320, or to ask control mechanism 340 to send data or information back to the external agent via communication means 370.

Local power supply 330 provides the power within remote device 320 to perform the intended function of remote device 320. This could be done via the means of a rechargeable circuit using a super capacitor or some form of rechargeable battery. Said rechargeable circuit being externally charged by an appropriate mechanism such as a connector on the shell 310 of remote device 320, or via some form of RF or inductive coupling of energy transfer, as is well known in the art. It is also possible that local power supply 330 is a single use power supply wherein once the battery or other power storage medium is depleted, remote device 320 is discarded. An alternate means for the power source is to place a battery or other power storage facility in shell 310 in such a way that it is replaceable. Still another power source is one wherein remote device 320 generates its own power and/or stores its own generated power. For example, one could imagine fitting remote device 320 with solar cells to provide power. Or a radio-thermonuclear generator (RTG) could be used. In some instances, the action of the motion of remote device 320 through its medium 210 could be used to generate power, for example if remote device 320 were crossing magnetic field lines while in orbit around the Earth. In all cases, sufficient power must be stored and/or generated to ensure that the elements in remote device 320 have sufficient power to accomplish their mission.

Power control is hugely important for remote device 320 particularly when there is a one time use local power supply 330. If the local power supply 330 is large, one might consider transmitting data and/or information via communication means 370 in a frequent manner. However, if local power supply 330 is not a large amount of energy, one may need to consider radically different techniques for turning on and off the high power devices such as communication means 370. Failure to consider power control methods in remote device 320 will deeply limit its utility for its intended application.

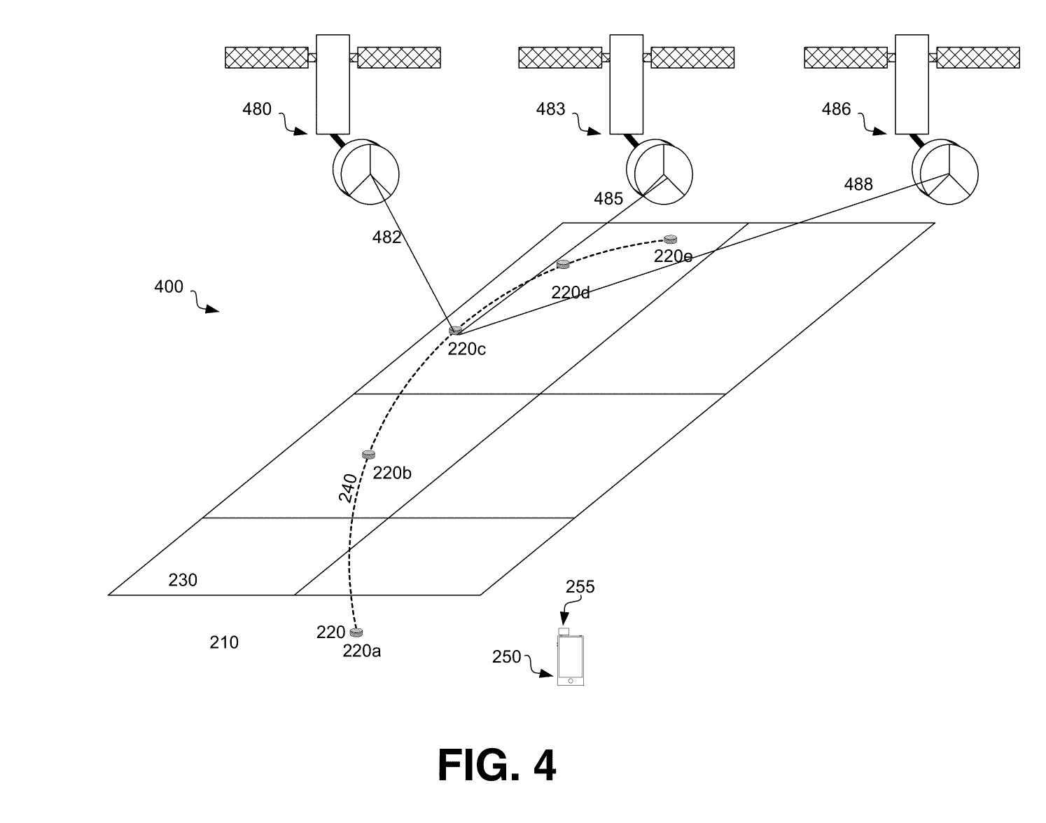

FIG. 4 shows an example embodiment identical to FIG. 2, except where the remote device 220 or 320 has a GPS or similar sensor embedded within sensor platform 350. In this case, satellites 480, 483, 486 represent a constellation of appropriate means that generates timing signals which the GPS sensor embedded within sensor platform 350 is able to identify 4D position. Since sensor platform 350 also contains a timing mechanism within control mechanism 340, it is possible to read the GPS or similar sensors over time to provide trajectory information. Typically this data is stored in memory 360, but may also be broadcast while remote device is along its trajectory 240 shown in both FIG. 2 and FIG. 4. Satellite 480, 483 and 486 are transmitting omni directional time codes on RF energy beams 482, 485 and 488. Remote device 220/320 receives particular time codes to enable remote device 220/320 to identify the distance and bearing to each particular satellite. For example, the combination of beams 482, 485 and 488 allow for a positioning calculation to be made using well known in the art geometry calculations called triangulation. Note that for 3D triangulation, at least four satellites are required; FIG. 4 is necessarily simplified to illustrate concepts, not specific implementation, and so omits the entire constellation of satellites present in a real system. Taken together then, a remote device 220 or 320 has a very powerful ability to measure and store its position at particular times. This position and time data can be stored in memory 360 for later retrieval, and/or can be sent via communication means 370. This data can in turn be analyzed by well known mathematical methods to produce a position and time map in 3D space and time known as a visualization. The trajectory derived from the data permits some very interesting new classes of information to be garnered including an X, Y, and Z direction and rate of spin, as well as the effect of perturbation by medium 210/310 on the trajectory. Additionally, identifying the rate of decay of any given data set permits knowledge of particular points in time such as apogee of flight over the trajectory. Importantly, these data not only can measure the trajectory in flight, but can be used to calculate where the trajectory should be. Further, knowing where the trajectory is supposed to lead the path of flight, and knowing where the remote device actually is allows a means to directly detect drift, e.g. wind effects on flight. If one had a closed loop system in remote device 220/320 wherein remote device 220/320 has the means to also affect its motion through medium 210, then one could use such means to actually aim for a specific point on multidimensional plane 230/330. Such means might include affecting the shape of remote device 220/320, using gyroscopes, fins, or even some form of propulsion to affect the ultimate flight path of remote device 220/320.

One skilled in the art of trajectory construction/reconstruction will immediately grasp the value of a time ordered list of data points which reference specific spatial-temporal relationships. Of particular interest in one embodiment of the present invention is the use of the time ordered data points to very precisely calculate the original imputation of motion to remote device 220/320. Depending on the context of remote device 220/320, it is possible to calculate very precisely where remote device 220/320 was hit at initial rest spatial-temporal position 220a in order to impart that particular directional energy and multidimensional spin axis to remote device 220/230. This knowledge in turn can be used to calculate how the remote device 220/320 was hit, and potentially even by what it was hit by. For example, if remote device 220/320 were a baseball hit by a wooden bat it would have a different set of characteristics than one hit by aluminum bat. Well known mathematics are able to determine very precisely where the baseball was hit, and what how much energy in what direction was imparted by the bat. These mathematics could then be used to analyze the posture, and indeed the swing required to impute that particular set of characteristic energy into remote device 220/320. Ultimately, this kind of feedback would permit the user of remote device 220/320 to understand how they are hitting the remote device 220/320, and could even suggest where to hit remote device 220/320 in the future as a training device to improve the accuracy of where remote device 220/320 will ultimately land.

In another embodiment of the present invention, it is possible to combine two remote devices where one is the element being hit and the other is the element doing the hitting. In such case, by precisely synchronizing the time stamps of the two remote devices, for example by using the moment in time where energy was first imparted as a synchronizing event, it would be possible to reconstruct with great accuracy the motion of the element doing the impingement of motion along with the results of that impingement. Taken together, the representation of such analytics can be a very powerful training device to the user of the remote devices.

In yet another embodiment of the present invention, it is possible to place a multitude of remote devices in such a way that players of a game could have their motion across time and 3D space recorded and/or broadcast. This would permit analysis of the strength of hits in terms of G-forces and resultant effects of the elastic collision. Those skilled in the art would also recognize that it would be possible to place a number of remote devices onto a person at specific locations such as feet, joints, hands, back, head, torso, etc. in such a way so as to very precisely represent that persons physical motion across time. Doing such to an entire team would permit real time or non-real time capture of their motion across a particular medium that they are playing in. Such structures would permit exceptionally complex analysis of multiple player team sports such as hockey, baseball, basketball, football, la crosse, etc.

In the present invention, one or more embodiments offer the presentation of information unto at least smart phone 250 from one or more remote device 320s. The actual presentation of the information is to what ever suits the intended use of remote device 320. For example, if the remote device were a baseball, and the user was a baseball player, they would most likely want to know at least what direction and speed the ball was coming at them, what direction and speed it was hit at, and the direction and distance of the ultimate hit. But they might also want to know what kind of spin the ball had coming to them, as well as what spin they imparted to it upon hitting with the bat. They would likely also want to see a trajectory of where the ball began its motion (e.g. the pitch), and how that looked in 3D space-time as it was arriving toward the player, and then looking at how their particular bat swing hit the ball in a particular way and imparted a particular energy in a particular set of dimensions. They might also like to see how the wind in the air (e.g. medium 210) affected the flight of the ball through the air, particularly if the ball was spin stabilized. The way this class of information could be presented is widely varied. For example, if the user were a scientist, they may only be interested in raw data like X, Y, Z spin rate information. In such a case, a set of numbers displayed upon the screen of smart phone 250 would be a sufficient display. However, the more interesting is to provide a 3D-temporal representation (e.g. a 3D movie) that could be stepped forward or backward at any particular speed that suited the user. Such 3D-temporal representation allows the user to slow down or speed up physical phenomenon and see it occur at a speed that the human brain can process. For example, by placing a dot on the representation of the baseball on the screen of the smart phone 250, one could very accurately see the rate and direction of spin that the ball has. One could also add planar origin lines such that the {X[0], Y[0], Z[0]} position is shown at the exact center of the ball, with a line radiating out from the axis origin to show where each axis is. This permits a different form of visualization on the screen of smart phone 250. Significantly, it is the visualization in non-real time that truly helps users of smart device 320 understand the underlying physics, and more importantly to attempt to make adjustments to control what happens the next time they hit remote device 320. Thus, the visualization, in what ever appropriate form is deemed useful for teaching, is a vital new feedback capability that the present invention offers. Those skilled in the art of reconstruction will recognize that different uses of remote device 320 will desire different representations on smart phone 250 or similar device. For example, what a person playing golf cares about and wants to see is different from what a basketball player wants to see for visualizations. Importantly, these visualizations are the end product which most help train the player or user of remote device 220/320 to improve any particular aspect of their sport.

In one embodiment of the present invention, the remote device is capable of constant transmission of information. Clearly, the remote device must have sufficient power, or be able to obtain it during the course of its use in such a mode because the power draw for constant transmission is higher. Alternatively, the user can simply accept lower life in the remote device.

In another embodiment, the remote device bursts data or information using the transmission capability. This remote device will typically have a longer life to its local power supply because the transmitter is switched off during the stasis. Additionally, pulsed transmission power may be used to provide longer distance transmissions of specific information or data.

Given a remote device which is capable of transmitting information either by burst, or constantly, a new capability now exists that is of interest to viewers of the users of remote device. Such an audience can be shown reconstructed visualizations of the remote device over time by having a means to receive the data or information from remote device 320, and then a means to analyze and display resultant information to the viewers. In most sports, this means that there would be a radio transceiver which receives motion, position, and time updates from remote device 320, and which then has a processing capability to provide appropriate data analytics, which in turn are used to generate appropriate representation to the viewers via any of a number of well known means of transportation of that information such as over the air TV transmission, cable TV transmission or internet TV transmission. Of course such information might be time delayed to said viewers for any of a number of technical, business or even moral reasons.

Importantly, in one embodiment, the usage of one or more remote devices combined with reception, analytics, and representative visualization of the data can be used to create a system that provides judgement against a particular sport's set of rules. For example, in hockey, did the puck actually cross the goal line or not can now be directly determined because the exact position of a puck is known relative to the position of the goal line on the ice. Or, in a collision between players, where injury results, it is possible to calculate the extent and perhaps even location of injury which will help a medical clinician to determine an appropriate course of action, and even the severity of the injury. Ultimately, such analysis produced over many events helps equipment manufacturers figure out better ways to protect the users of remote device 320 from being injured during use.

Those skilled in the art of data analytics will know from experience that analytical methods are constantly being improved. Thus, what today looks like an intractable problem is tomorrows 1st grade word problem. More interestingly, for analytics to improve, more often than not, more data is required. To that end, the present invention anticipates changes in the mathematics and algorithms that are present today, and assumes that different algorithms will evolve over time as needed for a particular use, especially as more data is made available to researchers. For example, perhaps in the future someone will want to be able to predict a particular player's ability with a particular set of other team members and a particular location. Based upon past data capture of that players remote device 320 usage, it is possible to identify long term trends and behaviors that are otherwise invisible to human perception.

While known to many in various arts, it is very rare that an average person has an opportunity to see some aspect of themselves over both an exceptionally long and exceptionally short period of time. For a person using a remote device 320 in some particular sport of interest, the present invention offers a means to bring to nearly anyone the ability to see both short duration and long duration trends. For example, if one is a golfer who plays the same course often, being able to see how each time they tried to hit hole 4, they behaved in a particular way, would be exceptionally useful feedback for improving on that particular hole. Seeing how they played a particular course over a number of different times is also of interest to training. If one were to combine that with data from other players, even more learning via direct feedback is possible. For those designing courses, knowing how players actually play their course offers opportunities to tune the course, or change the course to effect a different kind or style of play. It should be understood that golf in this example is a proxy for other sports. The entire point here is that by having useful visualization data, humans can change the way they behave, and/or can change the particular field, course, sheet of ice, etc to better accommodate some intended change.

While the invention herein has been described in specific illustrative terms, the invention is not intended to be limited to those terms, nor by the conceptual drawings herein. Those skilled in the art can recognize a number of different means to produce a remote device 220/320 with the characteristics shown herein. Thus, what works in golf may not work in basketball, and so a different physical manifestation would be required. The present drawings are not intended to represent the full and entire physical representation, merely one of a myriad.

Although the invention has been described with reference to particular embodiments thereof, it will be apparent to one of ordinary skill in the art that modifications to the described embodiment may be made without departing from the spirit of the invention. Accordingly, the scope of the invention will be defined by the attached claims not by the above detailed description.

What is claimed:

1. An apparatus called a remote device having
means for determining spatial position at a particular moment in time, and
means for memorizing said spatial data in a temporal way, and
means for communication to outside world, and
means of providing local power to said remote device.

2. The remote device of claim 1 where the communication means is a radio frequency (RF) radio with at least transmission capability, or with transceiver capability

3. The remote device of claim 1 where the communication means uses at least one or more light emitting device, or with one or more light emitting and light reception device; said light emitting device may also be used for visual identification purposes of said remote device; said light receiving device may also be used to detect light and position of light relative to the remote device.

4. The remote device of claim 1 wherein said means of providing power includes a rechargeable power unit and a means to charge said rechargeable power unit from outside the remote device.

5. The remote device of claim 1 wherein the means to track flight through medium is a Global Positioning Satellite (GPS) radio used to record at least the initial and final position of said remote device; said GPS radio may also be used to record positions during flight through medium.

6. The remote device of claim 1, wherein sensors appropriate to the specific use of said remote device are included with one or more of temperature sensor, barometric pressure sensor, gravity sensor, acceleration sensor, magnetic sensor, touch sensor, light sensor or other sensor appropriate to the requisite use of said remote device. Said one or more sensors providing spatial and temporal data as appropriate to their intended function in said remote device.

7. The remote device of claim 1, having a
means to calculate information of interest from spatial-temporal data

8. A method to analyze data communicated from a remote device that tracks and records various sensor data in spatial and temporal ways, wherein said data from said remote device is mathematically analyzed to produce information valuable to the user of the remote device

9. The method of claim 8 wherein analysis of said data provides 2D, 3D, or 4D location information.

10. The method of claim 8 wherein analysis of said data provides 2D, 3D, or 4D spatial and temporal information

11. The method of claim 8 wherein analysis of said data provides feedback information using means appropriate to the user of said remote device to understand the unique one or more trajectories that one or more remote devices have provided so as to use said feedback information to improve upon the conditions that cause subsequent impingement of movement to said remote device.

12. The method of claim 8 wherein analysis of said data provides feedback information using means appropriate to display said feedback information of said remote device to provide real time, or near real time additional information of value to spectators of said remote device.

13. The method of claim 8 wherein said information returned from analysis includes one or more of initial conditions to said remote device; or initial impingement conditions such as G forces in 2D, 3D or 4D; or 2D, 3D or 4D trajectory before, after or during movement; or, representation of spin, direction and effects of spin on movement; or, spin, direction and effects of spin on initial impingement of motion; or, of effects on movement through a medium on spin, direction and movement through said medium.

14. A system consisting of a computer, tablet, or smart phone coupled with a means of communication to a remote device; said remote device having at least means to memorize temporal sensor data appropriate to the purpose of said remote device; wherein said system provides ability to either internally or remotely analyze said temporal sensor data communicated from said remote device displaying analyzed information in means appropriate to user of said system, wherein said system may also include a means for user to include or enter other data or information which may be used by said system to provide said analyzed information.

15. Said system of claim 14 wherein a user is provide with 2D, 3D or 4D location information

16. Said system of claim 14 wherein a user is provided with feedback information to improve upon the skill of the user in impinging movement to said remote device.

17. Said system of claim 14 wherein information is shared from said system to a larger computer and/or display system for the purpose of 2D, 3D or 4D reconstruction of movement to display said movement to spectators of said remote device.

18. The remote device of claim 1 having means to be given a priori knowledge of terrain said remote device might encounter.

19. A system consisting of a computer, tablet, or smart phone coupled with a means of communication to multiple remote devices; said remote devices having at least means to memorize temporal sensor data appropriate to the purpose of said remote devices; wherein said system provides ability to either internally or remotely analyze said temporal sensor data communicated from said remote devices displaying analyzed information in means appropriate to user of said system, wherein said system may also include a means for user to include or enter other data or information which may be used by said system to provide said analyzed information.

20. The system of claim 19, further consisting of a means to evaluate multiple trajectories from multiple remote devices to provide additional visualizations which take into account the interrelationship between multiple trajectories and which offers additional useful detail to a user of said system.
